(19) United States
(12) Patent Application Publication
(10) Pub. No.: US 2009/0080225 A1
(43) Pub. Date: Mar. 26, 2009

(54) VOLTAGE SOURCE CONVERTER AND METHOD OF CONTROLLING A VOLTAGE SOURCE CONVERTER

(75) Inventor: Frans Dijkhuizen, Vasteras (SE)

Correspondence Address: VENABLE LLP, P.O. BOX 34385, WASHINGTON, DC, 20043-9998, US

(73) Assignee: ABB Research Ltd, Zurich (CH)

(21) Appl. No.: 12/159,618

(22) PCT Filed: Dec. 28, 2005
(86) PCT No.: PCT/SE2005/002053

§ 371 Date: Jun. 28, 2008

(51) Int. Cl. H02M 7/68

(52) U.S. Cl. 363/65

(57) ABSTRACT

A voltage source converter for conversion between dc and ac voltage includes at least two serially connected phase legs. The outputs of the conversion stages form phase outputs to be connected to a phase of an alternating voltage network via a respective transformer. The configuration of the conversion stages reduces the requirements on the individual components of the voltage source converter.

### FIELD OF INVENTION

The present invention relates generally to a voltage source converter for converting direct voltage into alternating voltage and vice versa and more particularly to a VSC converter having improved performance as compared to prior art converters. The invention also relates to a method of controlling a voltage source converter.

### BACKGROUND

A voltage source converter (VSC converter) is a device connected between a dc-voltage network and an ac voltage network and is subjected to forced commutation for transmitting electric power between the voltage-source dc-voltage and ac voltage networks connected thereto. One application of VSC converters is in High Voltage Direct Current (HVDC) applications, in which they offer a plurality of considerable advantages. Of these advantages can be mentioned that the consumption of active and reactive power may be controlled independently of each other and that there is no risk of commutating errors in the converter and hence no risk of commutating errors being transferred between different HVDC links.

An overview of an HVDC system is shown in FIG. 1, wherein two VSC converters labeled “ac/dc” and “dc/ac” are interconnected between two three-phase systems 29, 30, 31 and 29′, 30′, 31′, respectively. Two pole conductors 19 and 20 are connected between the two VSC converters, together constituting an HVDC line. The VSC converters are arranged for converting direct voltage into alternating voltage and conversely as is conventional.

A prior art VSC converter is disclosed in the international patent publication WO 00/62409, which document is included herein by reference. The VSC converter disclosed in this publication is schematically illustrated in FIG. 2. Three phase legs 1,2,3 are connected in series, and a single phase transformer 22-24 is connected to each phase output with one winding thereof connected through a first end 25 to the phase output of the phase leg and through a second end 26 to a midpoint between two capacitors 27,28 connected in series and in parallel with the current valves of the phase leg. The other winding of the transformer 22-24 is connected to one phase 29-31 of a three-phase alternating voltage network. By connecting a transformer in this way to each phase leg a connection in series of the three phase legs is made possible, reducing the number of components.

The blocking voltage requirement of semiconductor switching devices of the turn-off type (i.e., Insulated Gate Bipolar Transistors—IGBTS) is inadequate for the blocking voltage requirements in very high voltage applications. For this reason, a series connection of IGBTs is utilized to perform the valve function. The valves are triggered, by the application thereto of a control signal to switch the valve from the blocking state to the conducting state and vice versa to perform the power conversion between the ac and dc terminals in both directions. The valves will experience either conduction losses or switching losses repetitively when switching between the two states. On account of the aggregate IGBT energy losses the dissipating capabilities of the IGBTs must comply the cooling capabilities of the adjacent cooling circuitry. As it is known in the art, the dynamic switching commutation losses are proportional to the switching rate of each valve, generally known as the converter pulse number.

### SUMMARY OF THE INVENTION

An object of the present invention is to provide a voltage source converter (VSC) of the kind initially mentioned, wherein the requirements on the individual components are reduced.

The invention is based on the realization that more than one conversion stage and more than one transformer can be provided for each phase leg, thereby reducing the dc insulation requirements and also potentially the required switching frequency of each valve.

According to a first aspect the invention there is provided a voltage source converter for conversion of dc voltage into ac voltage, and vice versa, comprising: at least two phase legs, each having a conversion stage, the output of which being adapted to form a phase output and to be connected to a phase of an alternating voltage network via a transformer, wherein the phase legs of the converter are connected in series, and wherein the opposite ends of the series connection formed by an outer end of a respective outer phase leg of the series connection are intended to be connected to a respective pole conductor of a direct voltage network, the voltage source converter being characterized in that each of said at least two phase legs comprises at least a further conversion stage, the output of which being connected to a further transformer.

Thus there is provided a voltage source converter wherein the dc insulation requirements are kept low.

In a preferred embodiment, each power conversion stage comprises a half bridge power converter, thereby keeping the number of components low.

In another preferred embodiment, each power conversion stage comprises a full bridge power converter. By using full bridge converters in the conversion stages, the apparent switching frequency can be increased. Also, the dv/dt on the transformers becomes lower than when using half bridge converters.

In a preferred embodiment, the transformers in each phase leg are connected in a cascade, improving dc insulation and enabling elimination of harmonics by means of phase shifting.

Further preferred embodiments are defined by the dependent claims.

According to a second aspect the invention there is provided a method of controlling a voltage source converter.

### BRIEF DESCRIPTION OF DRAWINGS

The invention is now described, by way of example, with reference to the accompanying drawings, in which:

FIG. 1 is an overview of a conventional HVDC system;

FIG. 2 shows a diagram of a prior art VSC converter;

FIG. 3 shows an overall diagram of a first embodiment of a VSC converter according to the invention;

FIG. 4 shows a diagram of a second embodiment of a VSC converter according to the invention;

FIG. 5 shows a diagram of a third embodiment of a VSC converter according to the invention;

FIG. 6 shows a diagram of a fourth embodiment of a VSC converter according to the invention;

FIG. 7 shows diagrams explaining pulse width modulation used in a VSC converter according to the invention; and

FIG. 8 shows diagrams of converter voltage and phase currents.

### DETAILED DESCRIPTION OF PREFERRED EMBODIMENTS

In the following a detailed description of preferred embodiments of the present invention will be given.

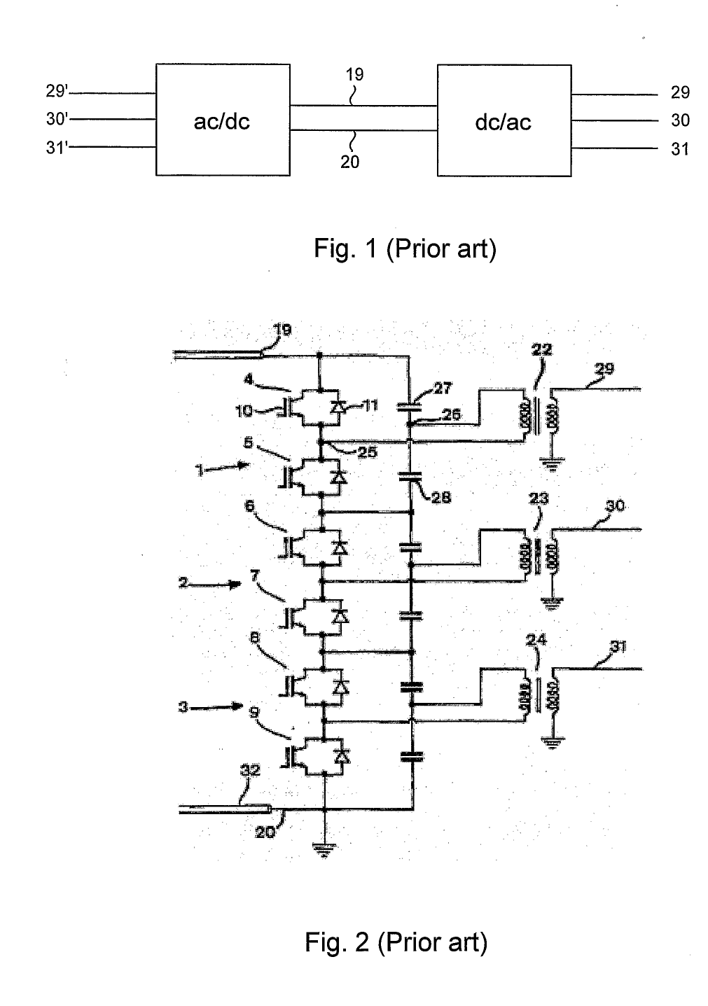

FIGS. 1 and 2 have been described under the background section and will not be further dealt with herein.

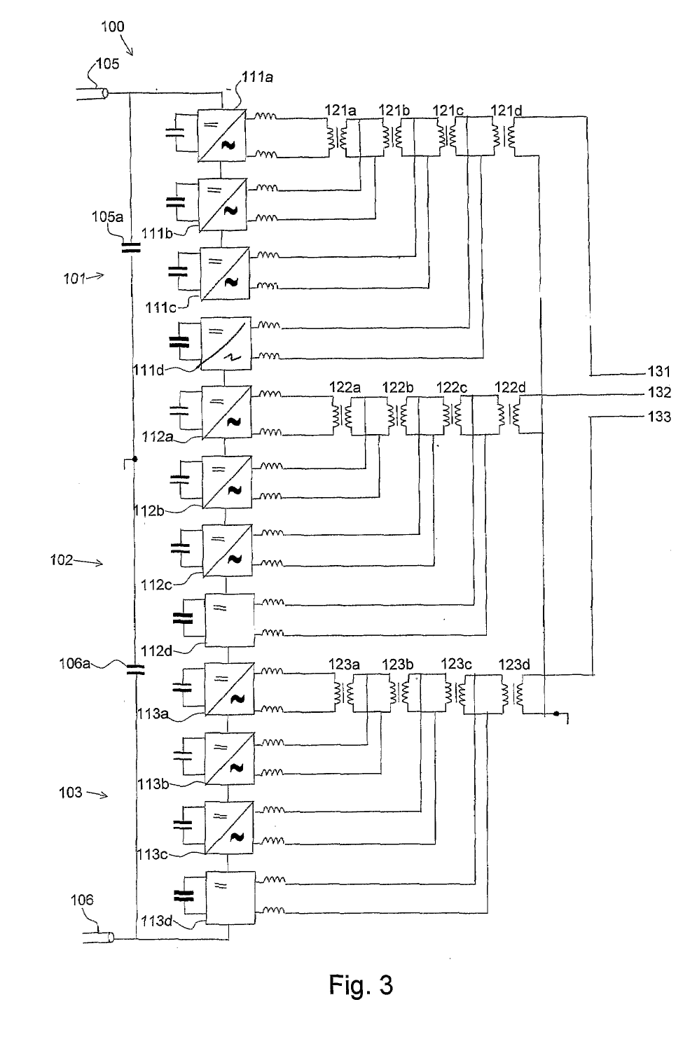

FIG. 3 shows an overall diagram of a first embodiment of a VSC converter according to the invention. It is in some aspects similar to the prior art converter shown in FIG. 2. Thus, three phase legs 101, 102, 103 are connected in series between two pole conductors 105, 106 of a direct voltage network. More specifically, one end of the first phase leg 101 is connected to the positive pole conductor 105 and one end of the third phase leg 103 is connected to the negative pole conductor 106. The second phase leg 102 is interconnected between the first and third phase legs. Thus, the opposite ends of the series connection formed by an outer end of a respective outer phase leg of the series connection are connected to a respective pole conductor 105, 106.

Each phase leg 101-103 comprises four power conversion stages 111a-d-113a-d, respectively. These conversion stages can be conventional half- or full bridge power converters. Capacitors and inductors are connected to the conversion stages in order to stabilize voltages and to smooth currents.

The conversion stages 111a-d-113a-d are connected in series in each phase leg 101-103, so that all conversion stages together form a series between the positive pole conductor 105 and the negative pole conductor 106. This means that a dc voltage is applied across the dc side of each conversion stage. In the VSC converter 100 shown in FIG. 3, there are three times four conversion stages, i.e., all in all twelve conversion stages. This means that one twelfth of the total voltage between the two pole conductors 105, 106 is applied across each conversion stage. This means in turn that the voltage requirements of the components of the conversion stages are less than if each phase leg comprised just one conversion stage. This also enables a higher link voltage, such as 10-400 kV.

The at least two conversion stages in each phase leg are controlled so as to achieve the desired dc or ac voltages.

In order to stabilize the dc voltage between the pole conductors 105, 106, capacitors 105a, 106a are provided between the two pole conductors. Also, a grounding point is provided between the two capacitors 105a, 106a.

The ac side of each conversion stage 111a-d-113a-d is connected to a first winding of a respective single-phase transformer 121a-d-123a-d. Thus, the two ac connections of conversion stage 111a are connected across the first winding of transformer 121a, the two ac connections of conversion stage 111b are connected across the first winding of transformer 121b, and so on.

The four transformers in each phase leg 101-103 are connected in a cascade. This means that the second winding of the first transformer in a phase leg is connected to the first winding of the second transformer in the phase leg, the second winding of the second transformer in the phase leg is connected to the first winding of the third transformer in the phase leg, and the second winding of the third transformer in the phase leg is connected to the first winding of the fourth transformer in the phase leg. The second winding of fourth transformer forms the phase output 131-133.

This connection of the transformers, so-called Greinacher cascade, avoids excessive dc insulation. Furthermore, the series connection of the high voltage transformer windings can also be avoided. The VA ratings of the transformers 121a-d-123a-d need not be equal.

By means of the serial connection of the conversion stages and the cascading of the transformers, several advantages are obtained. Firstly, since each transformer experiences only part of the phase voltage, the insulation requirements are smaller than in the prior art converter shown in FIG. 2, for example. Also, harmonic elimination is possible since the multiple converters per phase leg can be used for phase shifting of the carrier modulation.

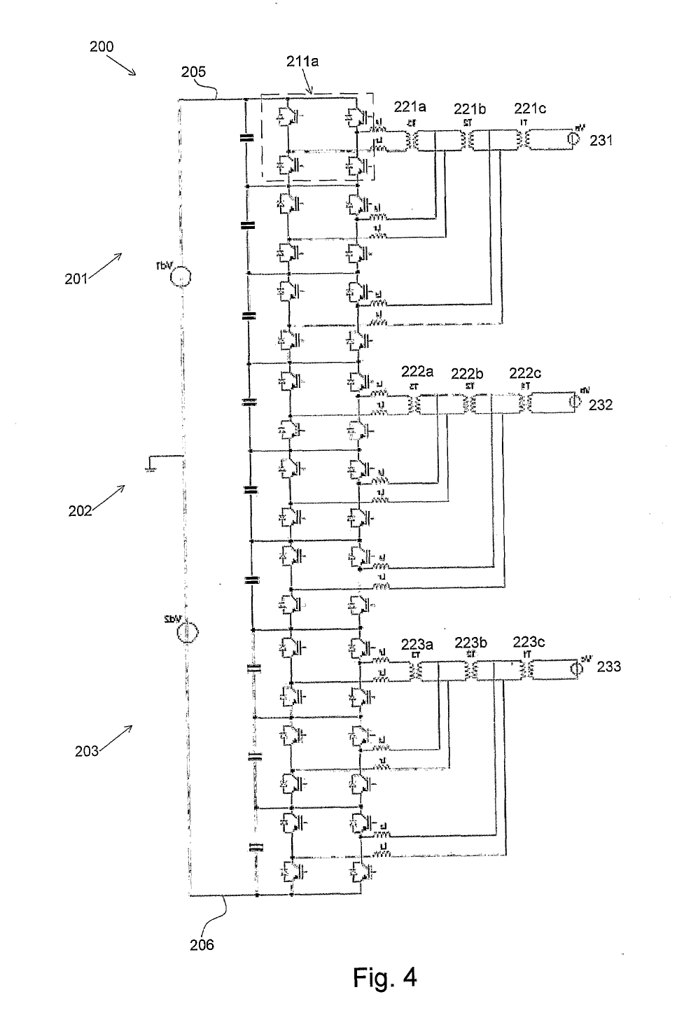

A detailed diagram of a second embodiment of a VSC converter 200 according to the invention is shown in FIG. 4. Like in the first embodiment, this converter comprises three phase legs 201-203 connected between a positive pole conductor 205 and a negative pole conductor 206. However, in this diagram just three power conversion stages 211a-c-213a-c are provided for each phase leg. This means that three transformers 221a-c-223a-c are cascaded for each phase leg.

Each power conversion stage is a full bridge converter comprising two legs each comprising two power valves, such as IGBTs. By using full bridge converters in the conversion stages, the apparent switching frequency can be increased. Also, the dv/dt on the transformers becomes lower than when using half bridge converters.

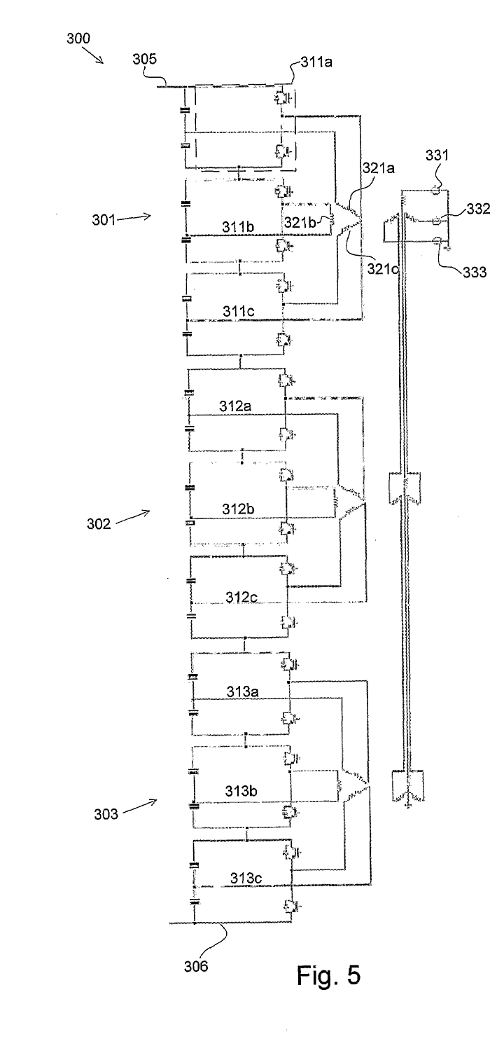

A diagram of a third embodiment of a VCS converter according to the invention is shown in FIG. 5. Like the second embodiment shown in FIG. 4, this VCS converter comprises three phase legs 301-303 connected between a positive pole conductor 305 and a negative pole conduct- or 306, with three power conversion stages 311a-c-313a-c serially connected in each phase leg. However, in this embodiment the conversion stages are half bridge converters wherein the converters in each phase leg are connected to a first winding of single phase trans-formers 321a-c-323a-c in an open delta configuration. By using half bridge converters in the conversion stages, the number of components is kept low.

The second windings of the single phase transformers 321a-c-323a-c are connected in series to provide three phase outputs 331-333.

This way of providing multiple phases by using transformers with an open delta connection gives a total power transformed per transformer of S=3UI, wherein U is the voltage exposed to one transformer winding and I is the current in each transformer winding.

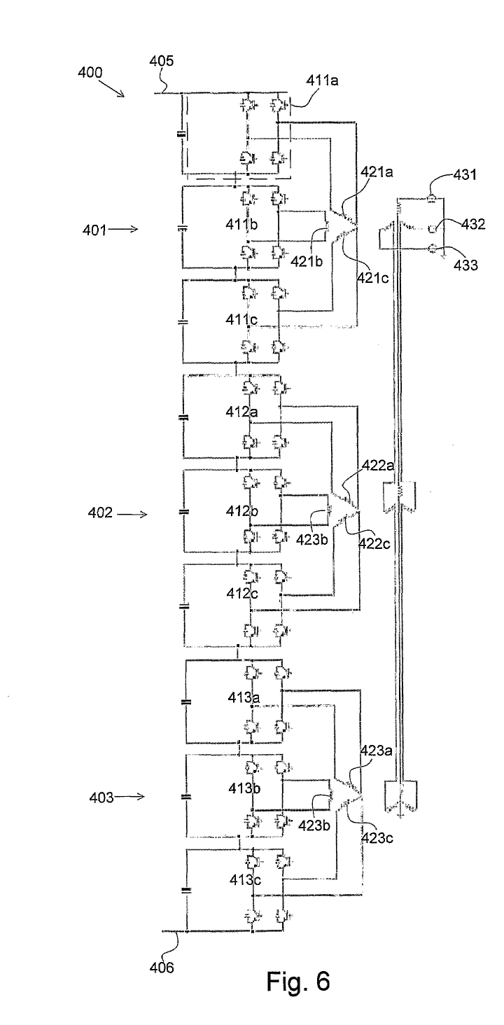

In a fourth embodiment shown in FIG. 6, a VCS converter according to the invention is identical to the converter shown in FIG. 5 with the exception that it comprises conversion stages which are full bridge converters instead of half bridge converters.

In all the described embodiments, pulse width modulation (PWM) is applied. Three sinusoidal waveforms are compared with triangular carrier waveforms. The triangular carriers can be mutually phase shifted in order to achieve harmonic elimination.

In the upper portion of FIG. 6, sinusoidal and triangular voltages are shown. The resulting PWM voltage is plotted in the lower portion of the same figure.

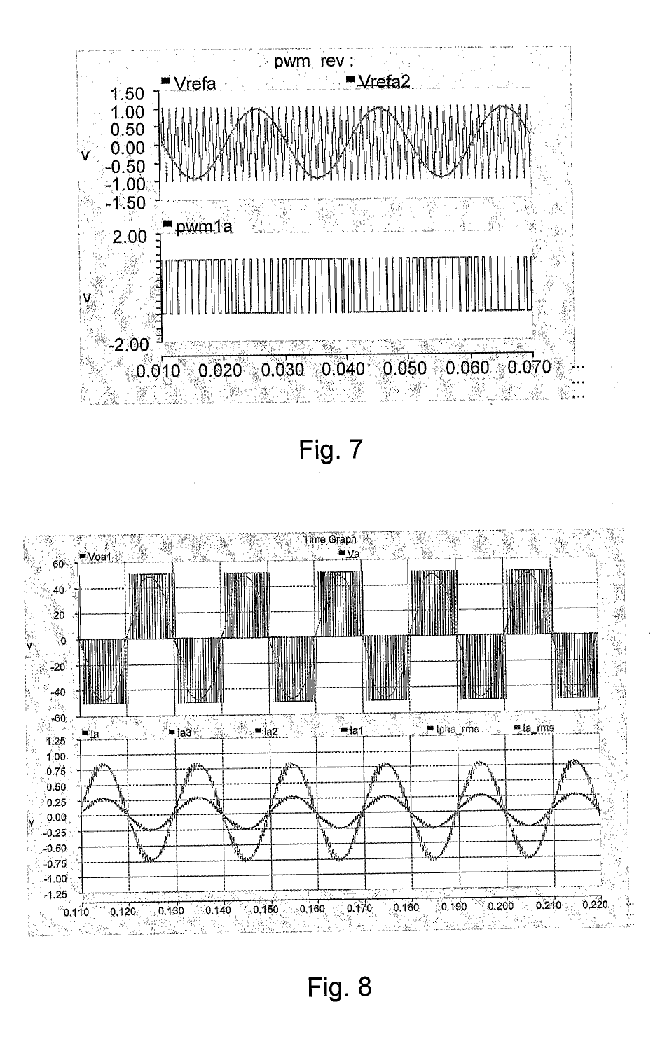

FIG. 7 shows in the upper diagram a time graph of the converter voltage with a pulse width modulation. In the lower diagram phase currents are shown.

Preferred embodiments of a voltage source converter according to the invention have been described. A person skilled in the art realizes that these could be varied within the scope of the appended claims. Thus, it will be appreciated that the number of phase legs can be extended to more than three or be just two phase legs. The advantages of having multiple phases are among others low valve voltage making a more compact design of the converter possible. Also, the more phase legs the lower the voltage stresses on the transformer. A possible application of VSC converters having more than three phases is in wind mills.

In FIG. 3, a grounding point is provided between the two pole conductors. It will be appreciated that one pole conductor can be connected to earth and the other to high voltage, so that so called monopolar operation is obtained and a low voltage, low cost cable may be used for the return current.

A PWM modulation based on sinusoidal and triangular waveforms has been described. It will be appreciated that also so-called optimized PWM using precalculated modulation could be used with the VSC converter according to the invention.

1. A voltage source converter for conversion of dc voltage into ac voltage, and vice versa, the voltage source converter comprising:
at least two phase legs, each having a conversion stage, an output of which is adapted to form a phase output to be connected to a phase of an alternating voltage network via a transformer, wherein the phase legs of the converter are connected in series, wherein opposite ends of the series connection formed by an outer end of a respective outer phase leg of the series connection are configured to be connected to a respective pole conductor of a direct voltage network, and wherein each of said at least two phase legs comprises at least a further conversion stage, an output of which is connected to a further transformer.

2. The voltage source converter according to claim 1, wherein the conversion stages are connected in series in each phase leg.

3. The voltage source converter according to claim 1, wherein each power conversion stage comprises a half bridge power converter.

4. The voltage source converter according to claim 1, wherein each power conversion stage comprises a full bridge power converter.

5. The voltage source converter according to claim 1, wherein the transformers in each phase leg are connected in a cascade.

6. The voltage source converter according to claim 1, wherein the converters in each phase leg are connected to a first winding of single phase transformers in an open delta configuration.

7. The voltage source converter according to claim 6, wherein the second windings of the single phase transformers are connected in series to provide three phase outputs.

8. The voltage source converter according to claim 1, wherein each phase leg comprises three power conversion stages.

9. The voltage source converter according to claim 1, wherein the number of phase legs is three.

10. A method of controlling a voltage source converter for conversion of dc voltage into ac voltage, and vice versa, said voltage source converter comprising:
at least two phase legs, each having a conversion stage, an output of which is adapted to form a phase output to be connected to a phase of an alternating voltage network via a transformer, wherein the phase legs of the converter are connected in series, wherein opposite ends of the series connection formed by an outer end of a respective outer phase leg of the series connection are configured to be connected to a respective pole conductor of a direct voltage network, and wherein each of said at least two phase legs comprises at least a further conversion stage, an output of which is connected to a further transformer,
said method comprising:
controlling, for each phase leg, at least two converter stages, the output of which being connected to a further transformer.
